(19) United States
(12) Patent Application Publication
(10) Pub. No.: US 2025/0330335 A1
(43) Pub. Date: Oct. 23, 2025

(54) APPARATUS AND NON-TRANSITORY COMPUTER-READABLE MEDIUM FOR ANONYMOUS AUTHENTICATION AND METHOD FOR MANUFACTURING

(71) Applicant: Intel Corporation, Santa Clara, CA (US)

(72) Inventors: Xiaoyu RUAN, Folsom, CA (US); William STEVENS JR., Folsom, CA (US)

(21) Appl. No.: 19/251,993

(22) Filed: Jun. 27, 2025

(51) Int. Cl. H04L 9/32; H04L 9/08

(52) U.S. Cl. CPC H04L 9/3268; H04L 9/0894

(57) ABSTRACT

Provided is an apparatus comprising interface circuitry, machine-readable instructions and processing circuitry to execute the machine-readable instructions. The machine-readable instructions include instructions to store a first plurality of cryptographic authentication credentials configured to authenticate the apparatus, wherein each of the plurality of authentication credentials is provisioned to a second plurality of different apparatuses and to select a first authentication credential from the first plurality of authentication credentials for authenticating the apparatus to a verifier. The machine-readable instructions further include instructions to transmit a certificate of the selected first authentication credential to the verifier for authentication and to receive revocation information from the verifier. The machine-readable instructions further include instructions to select a second cryptographic credential from the first plurality of cryptographic credentials based on a stored counting index if the received revocation information indicates that the selected first authentication credential is revoked.

### BACKGROUND

Computing platforms increasingly rely on secure and scalable authentication mechanisms to establish trust between electronic apparatuses and external verifiers. In many application domains, including cloud computing, client devices, and embedded systems, cryptographic credentials are used to identify devices, enforce access control, and support secure provisioning. There may be a demand for authentication techniques that preserve user privacy and minimize the risk of long-term device tracking or identification. For example, in environments involving sensitive data processing, such as Al model training or secure cloud workloads this may be important.

### BRIEF DESCRIPTION OF THE FIGURES

Some examples of apparatuses and/or methods will be described in the following by way of example only, and with reference to the accompanying figures, in which

FIG. 1 illustrates a block diagram of an example of an apparatus;

FIG. 2 illustrates a flowchart of an example of a method for manufacturing apparatuses;

FIG. 3 illustrates a flowchart of an example of a method;

FIG. 4 illustrates an example of provisioning of cryptographic authentication credentials across a fourth plurality of apparatuses;

FIG. 5 illustrates an example process of for anonymous and authentication using a first plurality of cryptographic authentication credentials;

FIG. 6 illustrates an example process for post-manufacturing provisioning of a first plurality of cryptographic authentication credentials;

FIG. 7 illustrates a graph of a probability that no apparatus in a fourth plurality of apparatuses becomes a victim due to credential compromise with x=1000;

FIG. 8 shows a graph of a probability that no apparatus in a fourth plurality of apparatuses becomes a victim due to credential compromise with x=100; and

FIG. 9 illustrates an example of a block diagram of an electronic apparatus incorporating at least one electronic assembly and/or method described herein.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

In some examples, every instance of an apparatus such as a system on chip (SoC) or another type of apparatus/device may be provisioned with a unique identifier (“device ID”), for example in the form of a certificate credential issued by the manufacturer. For example, a corresponding private key associated with the credential may also be provisioned. For example, an external entity (“verifier”) may use the device’ device ID to verify that the device is an authentic device, before collecting data from the device or providing service to the device. The verifier may identify the device throughout the device’ lifespan as the device ID in this case is unique and does not change. Such unique identification may raise privacy concerns in some examples.

Group signature schemes, such as Enhanced Privacy ID (EPID), may support privacy-preserving device authentication; however, such schemes may introduce notable implementation challenges in practical deployment environments. First, EPID may rely on complex cryptographic constructions beyond widely adopted standards such as ECDSA or RSA. As a result, integration with existing device identity infrastructure may be less straightforward. Second, EPID key and signature sizes may be comparatively large, which may significantly increase resource requirements and cost when implemented on constrained embedded devices. Third, EPID may employ a revocation mechanism that requires non-revoked devices to generate a revocation proof for each revoked credential. As the number of revoked entries grows, the size of the associated non-revocation proofs may become prohibitively large for devices with limited memory or processing capability.

The techniques described herein may provide a mechanism by which an apparatus may authenticate to a verifier without revealing a unique device identity. In some examples, a first plurality (x) of cryptographic authentication credentials may be provisioned to each apparatus, and each cryptographic authentication credential is further provisioned to a second plurality (y) of different apparatuses. When an apparatus transmits a certificate and proves possession of one credential from the first plurality during authentication, the verifier may confirm that the credential is valid and non-revoked, but is unable to determine which specific apparatus among the y apparatuses holding the credential initiated the authentication. In this configuration, the authentication signature verified using a given credential may have been generated by any one of the y apparatuses that share the credential. Because any two apparatuses are provisioned with disjoint or minimally overlapping sets of credentials, and no more than one credential is shared between any two apparatuses, the verifier cannot link authentications to a unique identity. Revocation of a compromised apparatus is achieved by revoking all credentials provisioned to that apparatus, thereby preventing further use without disclosing its prior identity.

This approach may achieve cryptographic anonymity for the apparatus in a manner compatible with standard public key infrastructure, enabling integration with existing authentication protocols such as Transport Layer Security (TLS) protocol or Security Protocol and Data Model (SPDM). The disclosed technique be used in systems-on-chip (SoCs), where maintaining user privacy may be essential, for example, in Al training applications that may expose sensitive user data such as browsing history. The disclosed technique may enable enhanced hardware-level privacy and may be deployed in high-volume client computing platforms including personal computers and servers.

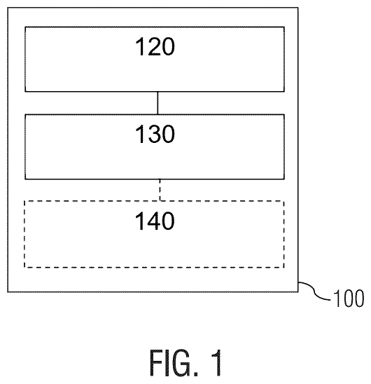

FIG. 1 illustrates a block diagram of an example of an apparatus 100 or device 100. The apparatus 100 comprises circuitry that is configured to provide the functionality of the apparatus 100. For example, the apparatus 100 of FIG. 1 comprises interface circuitry 120, processing circuitry 130 and (optional) storage circuitry 140. For example, the processing circuitry 130 may be coupled with the interface circuitry 120 and optionally with the storage circuitry 140.

For example, the processing circuitry 130 may be configured to provide the functionality of the apparatus 100, in conjunction with the interface circuitry 120. For example, the interface circuitry 120 is configured to exchange information, e.g., with other components inside or outside the apparatus 100 and the storage circuitry 140. Likewise, the device 100 may comprise means that is/are configured to provide the functionality of the device 100.

The components of the device 100 are defined as component means, which may correspond to, or implemented by, the respective structural components of the apparatus 100. For example, the device 100 of FIG. 1 comprises means for processing 130, which may correspond to or be implemented by the processing circuitry 130, means for communicating 120, which may correspond to or be implemented by the interface circuitry 120, and (optional) means for storing information 140, which may correspond to or be implemented by the storage circuitry 140. In the following, the functionality of the device 100 is illustrated with respect to the apparatus 100. Features described in connection with the apparatus 100 may thus likewise be applied to the corresponding device 100.

In general, the functionality of the processing circuitry 130 or means for processing 130 may be implemented by the processing circuitry 130 or means for processing 130 executing machine-readable instructions. Accordingly, any feature ascribed to the processing circuitry 130 or means for processing 130 may be defined by one or more instructions of a plurality of machine-readable instructions. The apparatus 100 or device 100 may comprise the machine-readable instructions, e.g., within the storage circuitry 140 or means for storing information 140.

The interface circuitry 120 or means for communicating 120 may correspond to one or more inputs and/or outputs for receiving and/or transmitting information, which may be in digital (bit) values according to a specified code, within a module, between modules or between modules of different entities. For example, the interface circuitry 120 or means for communicating 120 may comprise circuitry configured to receive and/or transmit information.

For example, the processing circuitry 130 or means for processing 130 may be implemented using one or more processing units, one or more processing devices, any means for processing, such as a processor, a computer or a programmable hardware component being operable with accordingly adapted software. In other words, the described function of the processing circuitry 130 or means for processing 130 may as well be implemented in software, which is then executed on one or more programmable hardware components. Such hardware components may comprise a general-purpose processor, a Digital Signal Processor (DSP), a micro-controller, etc.

For example, the storage circuitry 140 or means for storing information 140 may comprise at least one element of the group of a computer-readable storage medium, such as a magnetic or optical storage medium, e.g., a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), a fuse-based memory such as an electrical fuse (eFuse) or laser fuse, or a network storage. In some examples, the storage circuitry 140 may include a non-volatile memory element that is configured to retain stored authentication data even in the absence of power, such as a flash memory or fuse-based memory used to securely store cryptographic authentication credentials.

The processing circuitry 130 is configured to store a first plurality of cryptographic authentication credentials configured to authenticate the apparatus. Each of the plurality of authentication credentials is provisioned to a second plurality of different apparatuses. For example, each cryptographic authentication credential of the first plurality may not be unique to the apparatus 100 but may instead be shared across the second plurality of apparatuses. This may result in a many-to-many provisioning relationship, where each apparatus stores a plurality of credentials, and each credential is shared by multiple apparatuses. For example, the cryptographic authentication credentials may be configured to authenticate the apparatus 100 as a complete hardware entity. The apparatus 100 may be a system-on-chip (SoC), a computing module, or a discrete integrated device or the like.

For example, the cryptographic authentication credentials may be data structures configured to enable cryptographic authentication of the apparatus 100 to a verifier. Each of the cryptographic authentication credentials may represent a trust relationship established by a credential issuer and may be used in challenge-response authentication exchanges, digital signature verification, or secure session establishment (see below).

In some examples, each of the cryptographic authentication credentials may comprise a certificate and a private key. The certificate may include a corresponding credential public key, and a digital signature generated by an issuer using an issuer private key. The certificate may represent a digitally signed data structure that binds the credential public key to identifying information associated with the cryptographic authentication credential. The digital signature within the certificate may be computed by the issuer using the issuer private key and may cover at least the credential public key. In some examples, the digital signature may additionally cover further fields of the certificate if present, such as a subject identifier (e.g., a serial number or logical identifier of the apparatus), an issuer identifier (e.g., the name of the manufacturer), or a validity period (e.g., expiration date), thereby enabling a verifier to verify the integrity and authenticity of the credential public key and the associated identity information using a corresponding issuer public key. The credential private key may be securely stored by the apparatus 100 and used to generate digital signatures for authentication purposes, such as signing a challenge during a device authentication exchange with the verifier. The credential private key and the credential public key may together form a key pair, whereas the issuer private key and its corresponding issuer public key may form a separate key pair used for signing and verifying certificates.

For example, each of the cryptographic authentication credentials may comprise a structured data object including the certificate and the (apparatus) private key. The private key of the cryptographic authentication credential may be securely stored and never exposed outside the apparatus 100. The certificate may be a standardized digital object conforming to a public key infrastructure format such as X.509, which may encapsulate a set of fields that define the identity and validity of the cryptographic authentication credential. The certificate may also include the digital signature field generated by the issuer, which may be a certificate authority or device manufacturer. This digital signature may be computed over a canonical encoding of the certificate's data fields using a private key of the issuer.

For example, the issuer may be an entity authorized to generate and digitally sign certificates included in cryptographic authentication credentials. An issuer may operate as a root or intermediate certificate authority responsible for establishing the cryptographic trust basis within a trust domain comprising the apparatus and potential verifiers. In some examples, the issuer may sign the public key and additional information forming the certificate using a private key of the issuer, thereby allowing verifiers possessing the issuer's public key to authenticate the source and integrity of the credential. The issuer may also maintain records of credential issuance and revocation, enabling lifecycle management of the credentials. As one example, the issuer may be he manufacturer of the apparatus 100. For example, the issuer may generate and sign the certificates for the fourth plurality of cryptographic authentication credentials provisioned across a product family of apparatuses.

For example, the first plurality of cryptographic authentication credentials may be stored in a non-volatile memory (NVM) or a fuse-based memory. In some examples, the cryptographic authentication credentials may be provisioned during manufacturing of the apparatus or may be obtained after manufacturing. For example, the first plurality of cryptographic authentication credentials may be stored in a fuse-based memory, such as one-time programmable eFuses during manufacturing. In other examples, the cryptographic authentication credentials may be obtained after manufacturing, for example by downloading from an external provisioning service and stored in a rewriteable NVM, such as flash memory. For instance, the apparatus may be provisioned at manufacturing time with a first cryptographic authentication credential stored in a fuse-based memory, which may serve as a bootstrap credential. Subsequently, additional cryptographic authentication credentials may be downloaded and stored in a flash memory region for use during the operational lifetime of the apparatus 100 (see also below).

In some examples, the apparatus may further comprise the NVM which configured to store the first plurality of cryptographic authentication credentials. In some examples, the NVM may be a fuse-based memory or a rewriteable non-volatile memory. In some examples, the fuse-based memory may refer to a non-rewriteable memory medium integrated in a system-on-chip and may store credential data by physically modifying the fuse structure (e.g., blowing or trimming), which prevents subsequent rewriting and provides high tamper resistance. For example, the rewriteable non-volatile memory may include flash memory or EEPROM, which allows data to be erased and rewritten and may be more flexible for updating or replacing authentication credentials during runtime.

The processing circuitry 130 is further configured to select a first authentication credential from the first plurality of authentication credentials for authenticating the apparatus to a verifier. The selection scheme may be deterministic or non-deterministic and may take into account one or more parameters such as a stored counting index, a random number, a timestamp, or information related to credential revocation status.

For example, processing circuitry 130 may be configured to select the authentication credentials from the first plurality of authentication credentials in a predetermined order based on a stored counting index. In some examples, the processing circuitry 130 may maintain the counting index indicating the currently selected cryptographic authentication credential. In some examples, the stored counting index indicates a currently selected authentication credential from the first plurality of cryptographic authentication credentials stored by the apparatus 100. For example, the stored counting index may serve as an internal reference value maintained by the processing circuitry 130 and used to track the position within the first plurality of cryptographic authentication credentials. The counting index may indicate the currently selected authentication credential and may be stored in a persistent or volatile memory element accessible to the apparatus. The predetermined order may follow a sequential pattern, such as ascending numerical indexing of credentials from 0 to x−1, or any other defined sequence mapped to available credentials in storage. Such an approach may simplify credential management, facilitate revocation handling, and support reproducibility of authentication attempts. The counting index may be initialized to a starting value, such as zero, and may be incremented in response to revocation events or failures during authentication. This enables a sequential and predictable progression through the first plurality of cryptographic authentication credentials.

In further examples, the selection may be randomized to enhance privacy and unlinkability between successive authentications. In such cases, the processing circuitry 130 may employ a hardware or software random number generator to randomly select one of the stored cryptographic authentication credentials, subject to policy constraints such as excluding previously revoked credentials. In other examples, a hybrid scheme may be used, where a random selection is performed within a bounded subset of valid credentials as determined by a policy engine or a rule set. This approach may combine security, privacy, and resilience in the selection process.

In other examples, selection of the first authentication credential may also be guided by system policies, timestamps, cryptographic freshness indicators, or device-specific configuration data. This may allow more dynamic selection schemes such as round-robin, randomized, or rule-based access to a subset of authentication credentials.

In some examples, the processing circuitry 130 may be further configured to determine, prior to selecting the first authentication credential, whether the stored counting index is less than the total number of the first plurality of cryptographic authentication credentials. For example, the processing circuitry 130 may be further configured to perform a validation check on the stored counting index before selecting the first authentication credential from the first plurality of cryptographic authentication credentials. This validation may include comparing the current value of the counting index with the total number of available cryptographic authentication credentials stored by the apparatus 100. In some examples, this determination may serve as a safeguard to ensure that the value of the counting index remains within the valid bounds of the first plurality of cryptographic authentication credentials. The total number may represent the total provisioned credentials (e.g., five credentials indexed from 0 to 4), and the counting index must be less than this total to select a valid credential.

In some examples, the processing circuitry 130 may be further configured to abort the authentication to the verifier if it is determined that the counting index is not less than the total number of the first plurality of authentication credentials. In some examples, this functionality may act as a control condition to prevent out-of-bounds access to authentication credentials that do not exist in the storage. If the counting index equals or exceeds the total number of the first plurality of authentication credentials (e.g., index is 5, total number is 5), this may indicate that all of the authentication credentials of the first plurality have been previously revoked. In such a case, the processing circuitry 130 may discontinue the authentication sequence to avoid attempting to access an invalid or nonexistent credential. This may support security and operational consistency by ensuring that only valid and available credentials are used in the authentication protocol. Furthermore, the decision to abort may also trigger fallback procedures, such as error handling, user notification, or a transition into a credential re-provisioning state if supported. For example, when the apparatus has five cryptographic authentication credentials (indexed 0-4), and the counting index has reached 5, the apparatus may determine that all credentials have been revoked and may thereby abort the attempt to authenticate to the verifier.

For example, the verifier may be an external system or service configured to verify the authenticity of the apparatus 100 based on a cryptographic authentication credential presented by the processing circuitry 130. In some examples, the processing circuitry 130 may be further configure to receive a request from a verifier to authenticate the apparatus 100. Such a request may serve as a trigger for executing the authentication procedure. For instance, this may trigger the selecting of the authentication credential as described above. The request may be received via a communication interface 120. The verifier may send a request to authenticate the apparatus in order to establish trust before allowing access to protected resources, services, or communications. For example, the verifier may check if the requesting entity, such as an apparatus 100 attempting to connect to the verifier, is authentic and authorized.

The verifier may receive, evaluate, and validate the certificate transmitted by the processing circuitry 130 and may determine whether to establish trust based on the certificate's content and associated signature verification. In some examples, after the certificate is validated by the verifier, the verifier may perform a challenge-response protocol to assess whether the apparatus 100 is in possession of the private key associated with a received public certificate (see below). The verifier may also maintain or access revocation data such as credential revocation lists or online certificate status information, to determine the current validity of a cryptographic authentication credential. For example, the verifier may be a server or a cloud-based service endpoint that receives a certificate and a digital signature from the apparatus and determines whether the apparatus is authentic before authorizing access to data or initiating a secure session.

In some examples, the certificate of a cryptographic authentication credential comprises at least one of a: (credential) public key, a subject identifier, an issuer identifier, a validity period, or a digital signature issued of an issuer. For example, the (credential) public key may be the cryptographic key that is mathematically bound to the corresponding (credential) private key and may be used by a verifier to verify digital signatures generated by the apparatus using that corresponding private key. For example, the subject identifier may be a field in the certificate that designates the entity for which the certificate has been issued. The subject identifier may be uniquely associated with the apparatus 100 that holds the corresponding private key of the (credential) key pair. In the context of the certificate of a cryptographic authentication credential, the subject identifier may identify the apparatus within a product line, deployment, or secure network. For example, the subject identifier may correspond to a device serial number or embedded identity code.

For example, the issuer identifier may be a field in the certificate that specifies the issuer authority or entity that generated and signed the certificate. In the context of the certificate of the cryptographic authentication credential, the issuer identifier may point to the trusted manufacturer, platform root, or certificate authority. For example, the validity period may define the interval of time for which the certificate is to be considered valid by verifiers. The validity period may include a starting timestamp and an expiration timestamp, both included as fields in the certificate. The validity period applies to the usage of the associated apparatus key pair. For example, a certificate may specify that the public key is valid for authentication only between 2025 Jan. 1 and 2028 Dec. 31.

For example, the digital signature issued by an issuer may be a cryptographic value computed over certificate contents using the issuer private key of the issuer key pair. The digital signature may bind the (credential) public key of the (credential) key pair to the subject identifier and other certificate fields. For example, the digital signature may be an RSA or ECDSA signature over the public key, subject identifier, and validity period, signed using the issuer's private key.

The processing circuitry 130 is further configured to transmit a certificate of the selected first authentication credential to the verifier for authentication. For example, the processing circuitry 130 may be configured to transmit a certificate of the selected first authentication credential to the verifier in order to enable the verifier to assess whether the apparatus 100 is provisioned with a valid cryptographic identity. The certificate may comprise the public key and additional identifying information, digitally signed by the issuer, such as a manufacturer or certification authority. Upon receiving the certificate, the verifier may first verify the digital signature using the public key of the issuer to ensure the integrity and authenticity of the certificate and its content.

The verifier may then evaluate whether the certificate is still valid, for instance by consulting a credential revocation list (CRL) or an online status check. In some examples, the CRL may be digitally signed by a certificate authority. The certificate authority may be an entity that issues, signs, and manages certificates included in cryptographic authentication credentials. The certificate authority may be identical or distinct from the verifier but trusted by the verifier. For example, the certificate authority may be a manufacturer of the apparatus 100 or a dedicated trusted infrastructure provider that digitally signs the certificate using a private key, thereby enabling the verifier to authenticate the certificate using the corresponding public key. The verifier may validate the certificate by checking the issuer's digital signature using a stored or known public key of the certificate authority. This trust chain allows the verifier to confirm that the certificate, and by extension the apparatus 100, was authenticated by a trusted source.

The CRL may be used by the verifier to determine whether the cryptographic authentication credential presented by the apparatus 100 is still valid. The CRL may represent a digitally signed data structure that enumerates identifiers of cryptographic authentication credentials or certificates that have been invalidated before their scheduled expiration. In some examples, the CRL may include unique serial numbers, public key hashes, or other identifiers associated with the cryptographic authentication credentials, along with optional metadata such as a revocation date or revocation reason. The CRL may be periodically issued by certificate authority and digitally signed using a private key of the certificate authority to ensure authenticity and integrity. The verifier may use a corresponding public key of the certificate authority to validate the digital signature of the CRL before trusting its contents.

The verifier may check whether the received certificate or its associated identifier appears in the credential revocation information. If the certificate is listed, the verifier may identify the credential as revoked and may reject the authentication attempt and/or trigger a fallback procedure. If the certificate is not listed, the verifier may proceed with further authentication steps, such as a challenge-response exchange.

In some examples, the verifier may be configured to generate revocation information. In some examples, the revocation information indicates whether the selected first authentication credential is currently valid or has been revoked. In some examples, the revocation information may comprise a simple indicator, such as a binary flag or response message, specifying whether the credential presented by the apparatus 100 is included on a credential revocation list. The verifier may then transmit this revocation information to the processing circuitry 130, for example as an indication of whether the authentication credential is currently valid or revoked.

The processing circuitry 130 is further configured to the receive revocation information from the verifier indicating whether the selected first authentication credential is revoked. Accordingly, the revocation information received by the processing circuitry 130 may be the outcome of the verification, providing a clear indication of whether the selected first authentication credential should continue to be used or be replaced.

In some examples, the CRL may only be received by the processing circuitry 130 if the first authentication credential is revoked. For example, the CRL might not transmitted to the processing circuitry 130 if the first authentication credential being used is not revoked. This may improve performance because the CRL may be long. For example, the apparatus 100 may be careful about moving to using the next credential. The apparatus 100 might not move to the second credential simply because the verifier says the current first credential is revoked. The apparatus 100 might want to see the CRL as a proof that the first credential is indeed revoked, before moving to the second credential. However, if the verifier did not say the first credential is revoked, then the apparatus 100 might not need to see the CRL.

In some examples, if the revocation information received from the verifier indicates that the selected first authentication credential is valid, i.e., not listed in a CRL or otherwise marked as revoked, the verifier may initiate a cryptographic challenge-response exchange to confirm that the apparatus is in possession of the corresponding private key of the selected first authentication credential. To this end, the verifier may generate a challenge, for example in the form of a cryptographically random nonce or structured data token, and transmit the challenge to the processing circuitry 130 via the communication channel established between the verifier and the processing circuitry 130 of the apparatus 100.

In some examples, the processing circuitry 130 may be further configured to sign the challenge received by the verifier using the (credential) private key of the first authentication credential if the received revocation information indicates that the selected first authentication credential is not revoked. The signature may be computed using a digital signature algorithm such as ECDSA or RSA. The signed challenge may then be transmitted from the processing circuitry 130 to the verifier.

The verifier may be configured to validate the signature over the challenge using the (credential) public key contained in the received first authentication credential that was previously received from the apparatus 100. The verification confirms not only that the certificate is valid and unrevoked, but also that the apparatus 100 is in possession of the associated (credential) private key, thus establishing cryptographic authenticity and integrity of the apparatus 100. Because the private key is assumed to be securely stored within the apparatus 100 and never transmitted, successful signature verification provides strong evidence of possession of the private key. This process thus achieves two key security assurances: First the certificate was issued by a trusted issuer and is currently valid (i.e., not revoked); and second the apparatus 100 that transmitted the certificate is the legitimate holder of the credential private key associated with the credential public key. The combination of these two assurances establishes the cryptographic authenticity and identity integrity of the apparatus as seen by the verifier.

In some examples, the processing circuitry 130 may be further configured to establish a secure session to the verifier if the signature generated using the private key of the first authentication credential is verified successfully by the verifier. The secure session may rely on or be bootstrapped by the authentication just completed, and may be established using a cryptographic protocol such as the Transport Layer Security (TLS) protocol, the Security Protocol and Data Model (SPDM), or another mutually supported secure communication standard. The secure session may provide mutual authentication, confidentiality, and integrity for subsequent data exchange between the verifier and the apparatus. The successfully verified digital signature based on the private key of the selected first authentication credential may serve as the foundational security handshake element required to enter the secure session phase.

The processing circuitry 130 is further configured to select a second cryptographic credential from the first plurality of cryptographic credentials based on a stored counting index if the received revocation information indicates that the selected first authentication credential is revoked. In some examples, the processing circuitry 130 may be further configure to verify the CRL issuer's signature on the CRL to confirm that the first cryptographic credential is indeed on the CRL, before selecting the second cryptographic credential. The stored counting index may track which authentication credentials have already been used or attempted. Upon selecting the second cryptographic authentication credential, the authentication process is repeated as described above. That is, the certificate associated with the second cryptographic authentication credential is transmitted to the verifier. The verifier may validate the certificate, including checking whether it appears on a CRL or similar revocation source. If the certificate is found to be valid and not revoked, the verifier may initiate a challenge-response protocol. The processing circuitry 130 may then generate a digital signature over the received challenge using the (credential) private key corresponding to the selected second cryptographic authentication credential. Upon successful signature verification using the public key contained in the transmitted certificate, the verifier may establish a secure session with the apparatus.

This fallback and retry procedure may be repeated for each remaining cryptographic authentication credential in the first plurality of cryptographic authentication credentials, until a valid and unrevoked credential is found and successfully authenticated, or until all credentials in the first plurality have been exhausted. In some examples, the processing circuitry 130 may be further configured to abort authentication to the verifier, if it is determined that all authentication credentials in the first plurality of authentication credentials have been revoked based on the revocation information. This ensures that if the apparatus 100 is lacking at least one valid and unrevoked cryptographic authentication credential is not able to complete authentication with the verifier, thereby maintaining security and trust boundaries.

In some examples, the processing circuitry 130 may be further configured to increment the stored counting index and select the second cryptographic authentication credential from the first plurality in response to determining that the currently selected authentication credential has been revoked. That is, in some examples, the stored counting index may function as a position pointer within the first plurality of cryptographic authentication credentials stored by the apparatus 100. When the processing circuitry 130 determines, based on received revocation information, that the currently selected authentication credential has been revoked, the counting index may be incremented by one. The updated value of the counting index may then be used to select the next cryptographic authentication credential from the first plurality of cryptographic authentication credentials. This mechanism enables the apparatus 100 to sequentially iterate through the authentication credentials in the first plurality of cryptographic authentication credentials, avoiding reuse of previously attempted credentials. The use of the counting index ensures consistency in fallback behavior and prevents unnecessary revalidation of revoked credentials.

The apparatus 100 provides an architecture in which any two apparatuses share at most one credential in common, thereby enabling anonymous yet verifiable apparatus authentication. The apparatus 100 enables authentication without the need to assign a globally unique credential per apparatus, reducing provisioning complexity while maintaining compatibility with existing certificate-based infrastructures. The apparatus enables anonymous authentication and enables compliance with widely deployed cryptographic protocols. The apparatus 100 additionally enables to remain untraceable by external systems, thereby preserving user privacy in scenarios such as Al training applications that may involve sensitive data collection. The apparatus enables a privacy-preserving identity mechanism. The apparatus 100 further enables robust and resilient authentication behavior in environments where credential revocation may occur. The apparatus 100 enables continuous operation by selecting a second credential from the first plurality in response to revocation of a previously used credential. The apparatus may enable secure storage of credentials in fuse-based memory or rewriteable non-volatile memory, supporting both manufacturing-time and post-deployment provisioning workflows.

In some examples, the first plurality of cryptographic authentication credentials is selected from a third plurality of different cryptographic authentication credentials. The third plurality of different cryptographic authentication credentials may be distributed across a fourth plurality of apparatuses, such that any two apparatuses of the fourth plurality share at most one cryptographic authentication credential in common. This configuration provides a structured and privacy-preserving credential distribution scheme. The fourth plurality of apparatuses may represent a product family of apparatuses, such as a line of system-on-chip devices, computing platforms, or embedded systems produced by the same manufacturer. Each apparatus within this product family may be provisioned with a unique subset of authentication credentials, namely the first plurality of cryptographic authentication credentials, selected from the overall available set of cryptographic authentication credentials that is to be distributed, that is the third plurality of different cryptographic authentication credentials.

The provisioning is performed in such a way that, for any two apparatuses in the fourth plurality, the overlap in credentials is strictly limited to at most one shared cryptographic authentication credential. This constrained overlap improves unlinkability and limits the correlation potential between different apparatuses: even if two apparatuses present overlapping credentials to a verifier, the verifier can infer no more than a single potential commonality between them. This constrained provisioning scheme also significantly enhances privacy. When each apparatus draws its first plurality of credentials from a shared third plurality but with the one-overlap rule enforced, the probability of an adversary correlating identities or actions of multiple apparatuses is greatly reduced.

By maintaining controlled overlap and distributing credentials with these constraints, the apparatus 100 enables privacy-preserving device authentication in distributed or multi-tenant environments while ensuring that authentication can be performed without compromising the anonymity of the apparatus within its product family.

In some examples, the apparatus 100 may further comprise the NVM configured to store authentication data. The processing circuitry may be further configured to download the first plurality of cryptographic authentication credentials from an external source using the authentication data. This bootstrap authentication data may comprise a private key and a corresponding certificate. The bootstrap cryptographic authentication credential may be unique to the apparatus 100 and serve as a secure identity anchor that enables the apparatus 100 to authenticate itself to the external provisioning service after deployment. The certificate may include a public key corresponding to the authentication data private key and be digitally signed by a trusted issuer such as the apparatus manufacturer or a certificate authority, thereby enabling the external provisioning service to validate the authenticity of the apparatus.

That is the authentication data may be used to initiate a secure, mutually authenticated session with the external provisioning service. Mutual authentication may be achieved by executing a challenge-response protocol wherein the apparatus 100 proves possession of the authentication data private key, and the external service presents its own certificate for validation. Upon successful mutual authentication, the provisioning service may transmit to the apparatus 100 the first plurality of cryptographic authentication credentials. The first plurality of cryptographic authentication credentials may be downloaded over a secure transport channel such as TLS or SPDM and stored into the same or a separate NVM.

In some examples, the NMV may be a fuse-based memory. That is the authentication data may be stored in the fuse-based memory. For example, downloaded first plurality of cryptographic authentication credentials may be stored in a separate memory such as a rewriteable non-volatile memory, for example, a flash memory, that is integrated into the apparatus 100 or coupled via interface circuitry 120.

This two-stage mechanism, wherein a secure, immutable bootstrap authentication data is stored in a fuse-based memory, and a flexible set of operational credentials is subsequently provisioned into rewriteable flash memory, may enable a separation between manufacturing-time identity and runtime authentication credentials. This approach may further enhance device privacy and provisioning scalability: the bootstrap authentication data may not be reused for operational authentication, and the downloaded first plurality of cryptographic authentication credentials may be shared in controlled ways across a larger family of apparatuses, while maintaining unlinkability and revocation resilience as explained in the broader claim set. From a cost and production standpoint, this approach may offer advantages by minimizing the use of expensive, limited-capacity fuse-based memory, used only for storing the immutable bootstrap authentication data, while relying on lower-cost, higher-density rewriteable non-volatile memory such as flash for storing the operational authentication credentials. This split design may enable vendors to implement strong hardware-based trust anchors without incurring high per-unit manufacturing costs, making the solution viable across a wide range of system-on-chip platforms and consumer devices.

In some examples, the processing circuitry 130 may be further configured to initiate a provisioning procedure using the authentication data stored in the non-volatile memory when it is determined that all cryptographic authentication credentials of the first plurality have been revoked. In such cases, the processing circuitry 130 may authenticate itself to the external provisioning service using the bootstrap authentication data, for example by presenting a certificate and proving possession of the corresponding private key through a challenge-response exchange. Upon successful mutual authentication, the external provisioning service may transmit a new plurality of cryptographic authentication credentials to the apparatus 100. These newly provisioned credentials may then be stored, for example in the rewriteable non-volatile memory, such as the flash memory, and subsequently used to authenticate the apparatus 100 to verifiers in accordance with the standard procedure. This re-provisioning capability allows the apparatus 100 to extend its operational lifetime and maintain trust without requiring physical replacement or tamper-based credential resets. By separating the immutable bootstrap authentication data from the revocable operational credentials, the architecture supports robust credential lifecycle management while minimizing manufacturing costs, as only a single bootstrap credential needs to be embedded in secure fuse-based memory, and further credentials can be downloaded as needed.

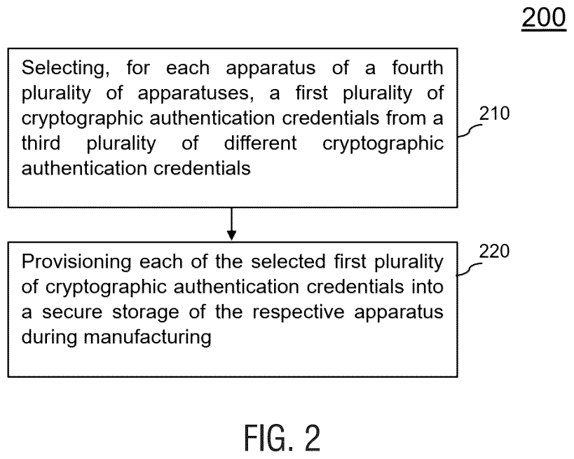

Further details and aspects are mentioned in connection with the examples described below. The example shown in FIG. 1 may include one or more optional additional features corresponding to one or more aspects mentioned in connection with the proposed concept or one or more examples described below (e.g., FIGS. 2-9).

FIG. 2 illustrates a flowchart of an example of a method 200 for manufacturing apparatuses. The method 200 may, for instance, be performed by a manufacturing apparatus and may manufacturer an apparatus as apparatus 100 described herein. The method 200 comprises selecting 210, for each apparatus of a fourth plurality of apparatuses a first plurality of cryptographic authentication credentials from a third plurality of different cryptographic authentication credentials. The method 200 may further comprise provisioning 220 each of the selected first plurality of cryptographic authentication credentials into a secure storage of the respective apparatus during manufacturing. Each cryptographic authentication credential of the third plurality of authentication credential is provisioned to a second plurality of different apparatuses of the fourth plurality of apparatuses. The selection of the first plurality of authentication credential for each apparatus is performed such that any two apparatuses of the fourth plurality of apparatuses share at most one cryptographic authentication credential of the third plurality of authentication credential of in common.

This manufacturing method defines how cryptographic authentication credentials are securely distributed and embedded into a set of apparatuses during production in a scalable and privacy-preserving manner. A constraint applied during the selection process is that any two apparatus of the entire product family (i.e., any two members of the fourth plurality) share at most one common cryptographic authentication credential. This constraint minimizes the probability that a revoked credential can be used to infer an apparatus' identity, thus strengthening unlinkability and privacy. This design also enables secure authentication of individual apparatus without globally unique device identifiers, which is particularly beneficial in privacy-sensitive applications.

The selection and distribution of credentials may be performed using a centralized provisioning system that ensures the correct mapping and records which credentials have been embedded into which devices. The secure storage of credentials, such as one-time programmable (OTP) memory or fuse arrays, may be programmed during trusted steps in the production process, often within a secure facility. In some configurations, the credentials can also be provisioned post-manufacturing using bootstrapped authentication, as discussed previously, which allows production cost optimization by shifting some security provisioning to later stages (e.g., in customer facilities or via remote provisioning).

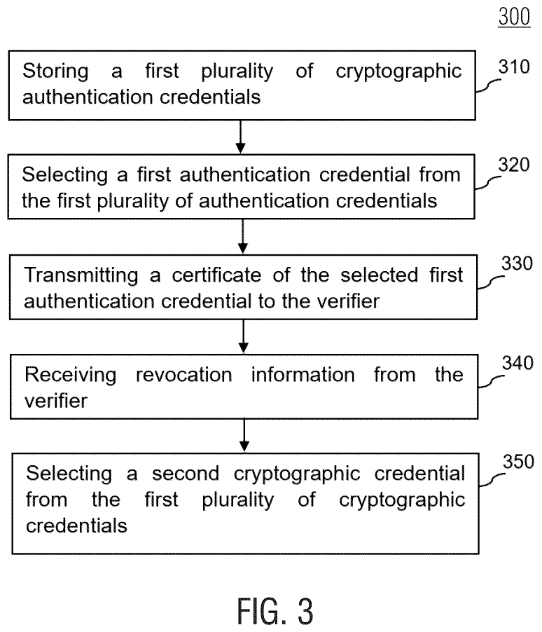

Further details and aspects are mentioned in connection with the examples described above or below. The example shown in FIG. 2 may include one or more optional additional features corresponding to one or more aspects mentioned in connection with the proposed concept or one or more examples described above (e.g., FIG. 1) or below (e.g., FIGS. 3-9).

FIG. 3 illustrates a flowchart of an example of a method 300. The method 300 may, for instance, be performed by an apparatus as described herein, such as apparatus 100. The method 300 comprises storing 310 a first plurality of cryptographic authentication credentials configured to authenticate the apparatus, wherein each of the plurality of authentication credentials is provisioned to a second plurality of different apparatuses. The method 300 further comprises selecting 320 a first authentication credential from the first plurality of authentication credentials for authenticating the apparatus to a verifier. The method 300 further comprises transmitting 330 a certificate of the selected first authentication credential to the verifier for authentication. The method 300 further comprises receiving 340 revocation information from the verifier indicating whether the selected first authentication credential is revoked. In some examples, the CRL may only be received if the first authentication credential is revoked. For example, the CRL might not be received if the first authentication credential being used is not revoked. This may improve performance because the CRL may be long. The apparatus 100 might not move to the next credential simply because the verifier says the current credential is revoked. For example, the apparatus may see a CRL as a proof that the first credential is indeed revoked, before moving to the second credential. For example, if the verifier did not say the first credential is revoked, then the apparatus 100 might not need to see the CRL. The method 300 further comprises selecting 350 a second cryptographic credential from the first plurality of cryptographic credentials based on a stored counting index if the received revocation information indicates that the selected first authentication credential is revoked.

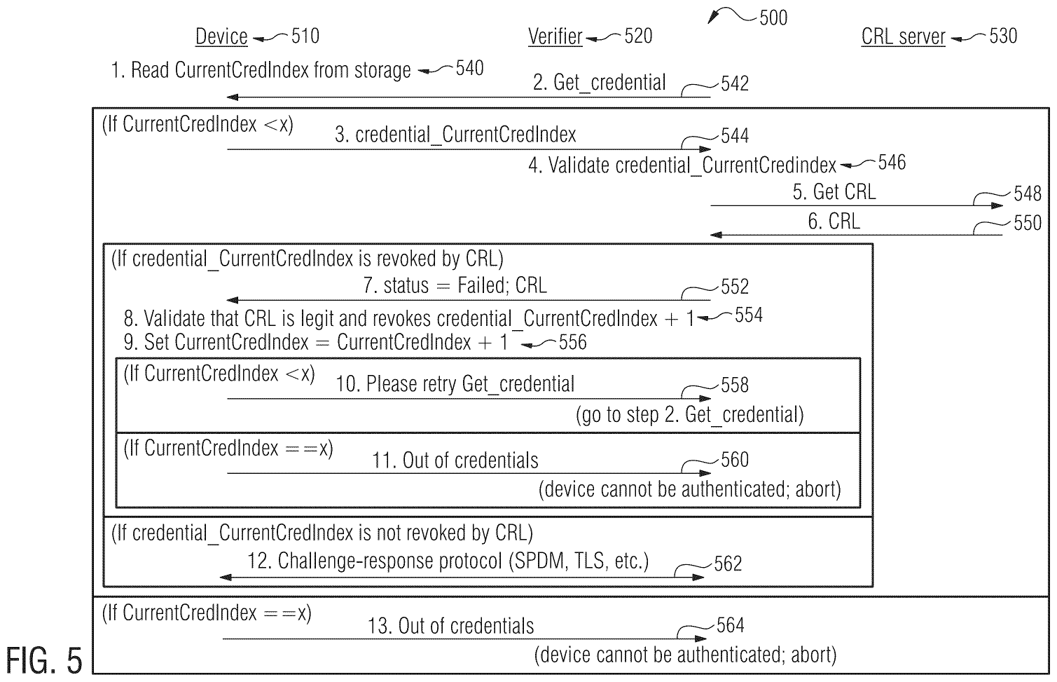

Further details and aspects are mentioned in connection with the examples described above or below. The example shown in FIG. 3 may include one or more optional additional features corresponding to one or more aspects mentioned in connection with the proposed concept or one or more examples described above (e.g., FIGS. 1-2) or below (e.g., FIGS. 5 9).

### FURTHER EXAMPLES

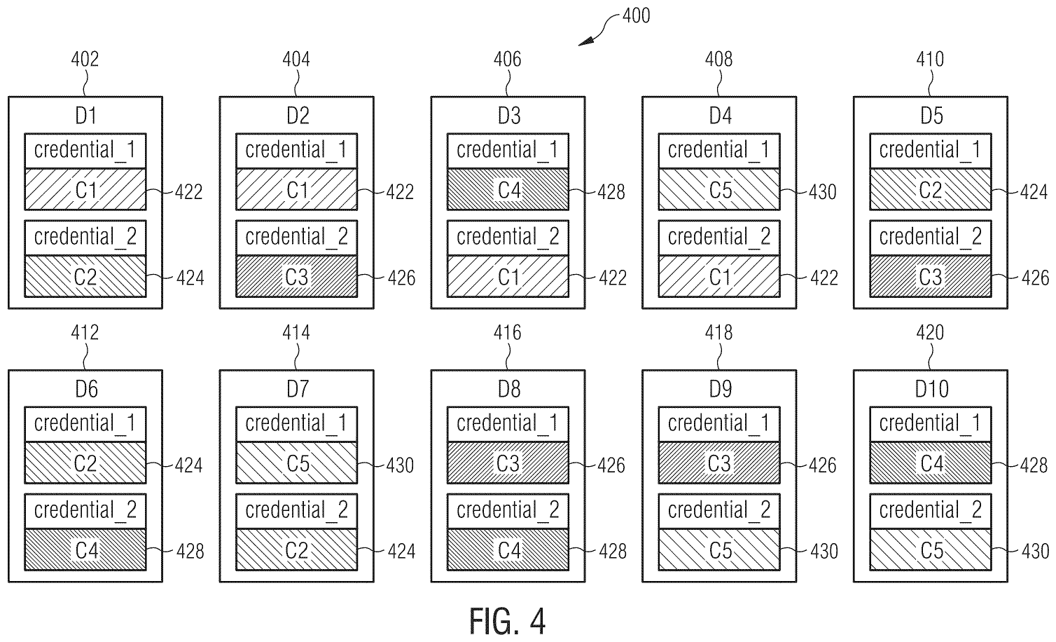

FIG. 4 illustrates an example of provisioning of cryptographic authentication credentials 400 across a fourth plurality of apparatuses. The fourth plurality of apparatuses comprises v=10 apparatuses, labeled D1 through D10 and referenced as 402, 404, 406, 408, 410, 412, 414, 416, 418, and 420, respectively. Each apparatus is provisioned with a first plurality x=2 of cryptographic authentication credentials. The cryptographic authentication credentials are selected from a third plurality n=5 of different cryptographic authentication credentials, consisting of credentials C1, C2, C3, C4, and C5, 422, 424, 426, 428, and 430.

Each apparatus includes two credential slots, labeled as credential 1 and credential 2. These slots store individual cryptographic authentication credentials of the first plurality. For instance, apparatus 402 (D1) is provisioned with credential C1 as credential 1 (422) and credential C2 as credential 2 (424). Similarly, apparatus 406 (D3) is provisioned with C4 and C1, and so on. The credentials are assigned such that each cryptographic authentication credential of the third plurality is provisioned to a second plurality (y) of different apparatuses, where y=4. For example, credential C1 appears exactly four times across apparatuses 402, 404, 406, and 408.

Each apparatus initially uses the credential stored in credential 1 for authentication to a verifier. If revocation information received from the verifier indicates that the selected credential has been revoked (e.g., via a credential revocation list), the apparatus verifies this status and increments a stored counting index to begin using the next credential in the first plurality, for example, credential 2. This fallback mechanism continues until a valid credential is found or until all credentials of the first plurality are revoked, in which case the apparatus is no longer able to authenticate and is considered revoked.

The example illustrate in FIG. 4 shows how the selection of the first plurality x=2 of cryptographic authentication credentials is performed such that any two apparatuses of the fourth plurality v=10 share at most one cryptographic authentication credential of the third plurality n=5 in common, preserving unlinkability and enhancing privacy. The distribution shown in FIG. 4 supports anonymous authentication at scale and enables revocation-resilient fallback while maintaining strong bounds on credential sharing across the product family.

Further details and aspects are mentioned in connection with the examples described above or below. The example shown in FIG. 4 may include one or more optional additional features corresponding to one or more aspects mentioned in connection with the proposed concept or one or more examples described above (e.g., FIGS. 1-3) or below (e.g., FIGS. 4 9).

FIG. 5 illustrates an example process 500 of for anonymous and authentication using a first plurality of cryptographic authentication credentials. The process 500 is performed for example by apparatus 100 as described with regards to FIG. 1. The process is carried out between apparatus 510, a verifier 520, and a CRL server 530. At step 540, the device 510 reads a stored counting index (CurrentCredIndex) from secure storage. The counting index indicates the currently selected credential from the first plurality of cryptographic authentication credentials stored by the device. At step 542, the device 510 retrieves the current credential associated with the counting index using a procedure Get_credential. In step 544, the device sends the selected credential (denoted credential_CurrentCredIndex) to the verifier 520. In step 546, the verifier 520 begins validation of the received credential.

To determine revocation status, in step 548, the verifier 520 sends a request to the CRL server 530 to obtain a credential revocation list (CRL). The CRL is returned in step 550. Then the verifier checks whether the current credential is revoked based on the CRL. In step 552, if the credential is found to be revoked, the verifier may return a status indicating failure (revocation information). The device 510 proceeds to step 554, where it validates the authenticity of the received CRL and confirms that the credential is indeed revoked. If so, in step 556, the device increments the counting index to select the next credential from the first plurality.

In step 558, the device checks whether the updated index is still less than the total number of credentials (x). If so, it loops back to step 542 to retry with the next credential. If the updated index equals x, indicating that all credentials have been used, the device proceeds to step 560, where it aborts the authentication due to being out of valid credentials.

If the credential is not revoked, the verifier 520 initiates a challenge-response authentication in step 562, such as SPDM or TLS. If successful, authentication is complete.

If the index is found to equal x before any challenge-response can proceed (e.g., after revocation fallback), the device may reach step 564, where it determines it is out of credentials and aborts.

This flow enables structured, secure authentication with revocation awareness and credential fallback. Each credential is selected based on a counting index and verified individually with support from an external verifier and CRL infrastructure. The fallback logic ensures that the device can attempt alternate credentials in a privacy-preserving manner until either authentication succeeds or the credential space is exhausted.

This process supports anonymous authentication while allowing for credential revocation resilience. The configuration parameters x and y are selected by the manufacturer during provisioning: A larger value of the second plurality y (i.e., the number of different apparatuses that share each cryptographic authentication credential) increases anonymity.

A larger value of the first plurality x (i.e., the number of credentials provisioned to each apparatus) enhances fault tolerance and recoverability but increases bill-of-materials (BOM) cost, as it requires additional secure non-volatile memory and associated provisioning infrastructure.

The secure non-volatile memory used to store the first plurality may be fuse-based (e.g., eFuses) or reprogrammable (e.g., flash memory), and storage area on-die is typically constrained, making storage cost a relevant consideration during device manufacturing.

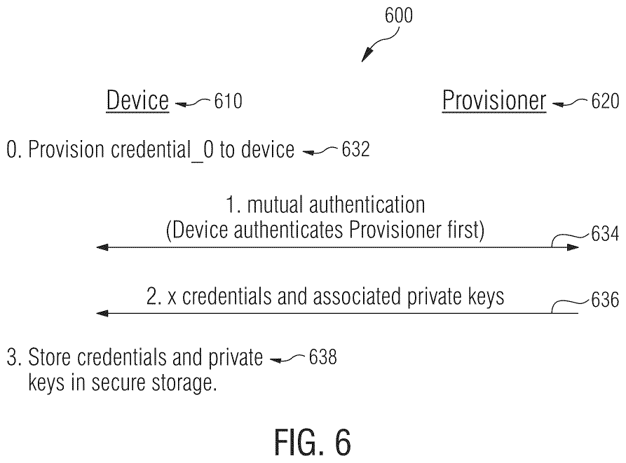

Further details and aspects are mentioned in connection with the examples described above or below. The example shown in FIG. 5 may include one or more optional additional features corresponding to one or more aspects mentioned in connection with the proposed concept or one or more examples described above (e.g., FIGS. 1-4) or below (e.g., FIGS. 6 9).

FIG. 6 illustrates an example process 600 for post-manufacturing provisioning of a first plurality of cryptographic authentication credentials. The process 600 takes place between a device 610 and a provisioner 620, such as an external provisioning service hosted by the device manufacturer or its delegate, and represents a secure credential provisioning flow based on mutual authentication. To address concerns related to the cost of provisioning and storing a larger number of cryptographic authentication credentials (i.e., the first plurality), one option is to defer the provisioning of these credentials to a later stage, for example when the device is first powered on during system manufacturing (e.g., at an OEM facility) or in the field by an end user. In this model, the device is initially provisioned during chip manufacturing with only a special-purpose credential, referred to as credential_0.

As shown in step 632, the device 610 is provisioned with credential_0 (authentication data) during manufacturing. The credential_0 is unique per device and is the only credential installed at production time. Its sole function is to authenticate the device to a trusted provisioner and enable the download of the first plurality of operational credentials. The credential_0 may be stored in a secure, immutable storage element such as fuse-based memory. In step 634, the device 610 and provisioner 620 engage in mutual authentication. The device 610 first authenticates the provisioner 620 to ensure it is a trusted source before releasing credential_0 and proceeding with the download. Mutual authentication may be conducted using a secure session protocol such as TLS or SPDM.

In step 636, upon successful authentication, the provisioner 620 transmits a first plurality of cryptographic authentication credentials and their associated private keys to the device. These credentials are selected from a third plurality of different cryptographic authentication credentials and are provisioned in accordance with the constrained overlap distribution scheme described in FIG. 4, such that each credential is shared across a second plurality of devices while maintaining unlinkability.

In step 638, the device 610 stores the downloaded credentials and private keys into a secure non-volatile memory. This storage may be implemented using rewriteable memory such as flash. The credentials provisioned in this step form the operational credential set for the device and are subsequently used for anonymous authentication to verifiers as described in earlier figures. The bootstrap credential_0 is not reused for operational authentication.

FIG. 6 illustrates a cost-optimized provisioning architecture that separates the bootstrap identity (credential_0) from the operational authentication credentials. By shifting the provisioning of the first plurality to system-level or field-level events, the architecture minimizes the need for expensive on-die storage during manufacturing and improves deployment flexibility while maintaining strong security properties.

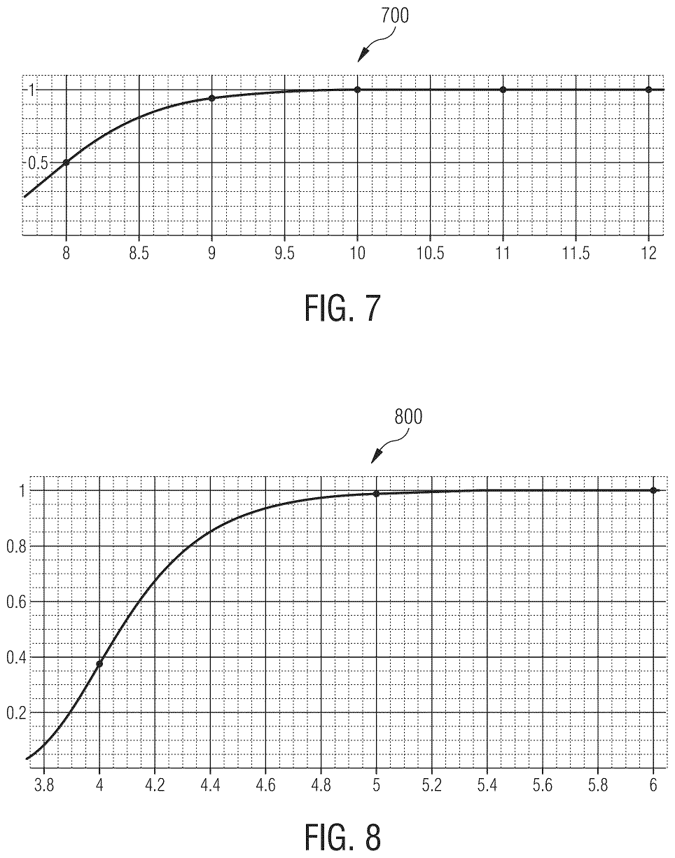

Further details and aspects are mentioned in connection with the examples described above or below. The example shown in FIG. 6 may include one or more optional additional features corresponding to one or more aspects mentioned in connection with the proposed concept or one or more examples described above (e.g., FIGS. 1-5) or below (e.g., FIGS. 7 9).

In some examples, the reason for provisioning multiple cryptographic authentication credentials to an apparatus is to mitigate compromise of other apparatuses that share the same cryptographic authentication credentials. For the example of FIG. 4, if D1 is compromised, then cryptographic authentication credentials C1 and C2 (422, 424) are compromised and must be revoked. As a result:
Both credentials on D1 are revoked. D1 has no valid credentials to use. This is a desired outcome.
As C1 is also provisioned to D2, D3, and D4, after C1 is revoked,
   D2 must use C3.
   D3 must use C4.
   D4 must use C5.
As C2 is also provisioned to D5, D6, and D7, after C2 is revoked,
   D5 must use C3.
   D6 must use C4.
   D7 must use C5.

However, if D1 and D2 are compromised, then C1, C2, and C3 (422, 424, 426) are revoked. As an undesirable result, D5 (with C2 and C3) would have no valid credentials to use, even though D5 is not compromised. D5 may be referred to a “victim” in this case. Due to Property that any two apparatuses share at most one common credential, for a victim to exist, the attacker must compromise at least x apparatus, each of which shares one credential with the victim. This significantly raises the difficulty of attacks and reduces the possibility of victims.

For example, if these criteria are met:
The fourth plurality (i.e., the volume v) is large (e.g., at the scale of hundreds of millions),
The chance of apparatuses being hacked is low (e.g., less than one in ten thousand), and
The credentials are randomly distributed among apparatuses, then, by carefully choosing the first plurality x and the second plurality, the chance that a victim exists may be sufficiently low.

The above described apparatus 100 and method 300 may be suitable when the above criteria are met, i.e., large volume of apparatus with strong mitigations against physical attacks. Compromising an apparatus should require highly skilled attacker with physical access to the target apparatus and advanced equipment. Because of the high bar, the cost of a successful attack should be very high (e.g., at or above “criminal enterprise” level). Therefore, the number of successful compromises should be very low. The volume of a given generation SoCs may be in the tens or hundreds of millions.

In the rare case that a victim is reported: If the shared authentication credentials to be provisioned after manufacturing is supported, then the victim apparatus may use the authentication data (credential_0) to retrieve a new set of x credentials.

Below an example to quantify the possibility of victimization and ways to minimize it are described. The variable x denotes the number of cryptographic authentication credentials provisioned to each apparatus (first plurality). The variable y represents the number of different apparatuses that share a specific credential (second plurality). The variable v indicates the total number of apparatuses in the deployment (the fourth plurality of apparatuses). The probability that a single apparatus is physically compromised by an attacker is denoted as PrH. Based on these inputs, the model defines several derived probabilities. The probability that a given credential is compromised-meaning that at least one of the y apparatuses holding that credential has been compromised-is denoted as PrC. The probability that a given apparatus becomes a victim (i.e., that all x of its credentials have been compromised due to compromise of x other apparatuses) is denoted as PrDV. Accordingly, the probability that an apparatus is not a victim is expressed as PrDNV=1−PrDV. Finally, the probability that no apparatus among the v apparatuses is a victim is defined as PrNV.

The probability PrC (that a credential is compromised) may be determined as follows This value is equal to one minus the probability that all y apparatuses sharing a given credential remain uncompromised:

$$PrC = 1 - {( 1 - PrH )}^{y}$$

PrDV, the probability of an apparatus being a victim (all x credentials on the device are compromised on other x devices, respectively), is:

$$PrDV = {PrC}^{x}$$

Probability of a device not being a victim:

$$PRDNV = 1 - PrDV$$

Probability of zero victims among the v devices:

$$PrNV = {PrDNV}^{v}$$

Putting above equations together, we arrive at

$$PrNv = {( 1 - ( {( 1 - {( 1 - PrH )}^{y} )}^{x} ) )}^{v}$$

The goal may be to maximize PrNV, which is a function of PrH, x, y, and v. Among the four, PrH and v can be considered constant. PrNV increases when y decreases. As y represents the level of anonymity, y cannot be too small.

PrNV increases when x increases. As x is related to the BOM cost, x might not be too large. For example, if PrH=0.01%=0.0001 and v=100,000,000, then:

$$PrNv = {( 1 - ( {( 1 - 0.999 {9}^{y} )}^{x} ) )}^{100000000}$$

For higher anonymity, it may be: y=1000, that is a credential is shared among 1000 apparatuses. Then it holds: 0.9999\hat{ }1000=0.904833; 1−0.904833=0.096167.

$$PrNv = {( 1 - 0.09516 {7}^{x} )}^{100000000}$$

The graph 700 of this equation is illustrated in FIG. 7. FIG. 7 shows a graph 700 of a probability that no apparatus in a fourth plurality of apparatuses becomes a victim due to credential compromise with x=1000. The graph 700 illustrates that as the first plurality of authentication credentials x increases, the probability of victim-free deployment also increases. This behavior reflects the fact that with more authentication credentials provisioned per apparatus (i.e., higher x), it becomes less likely that a non-compromised apparatus will lose all of its credentials due to revocation events caused by compromise of others.

If a lower level of anonymity is used, for example y=100, that is every authentication credential is shared among 100 devices it holds: 0.9999\hat{ }100=0.990049; 1−0.990049=0.009951.

$$PrNv = {( 1 - 0.00995 {1}^{x} )}^{100000000}$$

The graph of the equation is plotted below. FIG. 8 shows a graph 800 of a probability that no apparatus in a fourth plurality of apparatuses becomes a victim due to credential compromise with x=100. The graph demonstrates that with lower anonymity (smaller y), the probability PrNV drops unless x is chosen sufficiently large. The shape of the curve reflects a similar asymptotic behavior, but the required x for achieving high PrNV is higher than in FIG. 7, indicating that systems with smaller y require more credentials per device to maintain an acceptable risk of victimization.

Together, FIGS. 4 and 5 quantitatively illustrate the trade-off between anonymity level (y) and recoverability (x) in the proposed credential provisioning architecture.

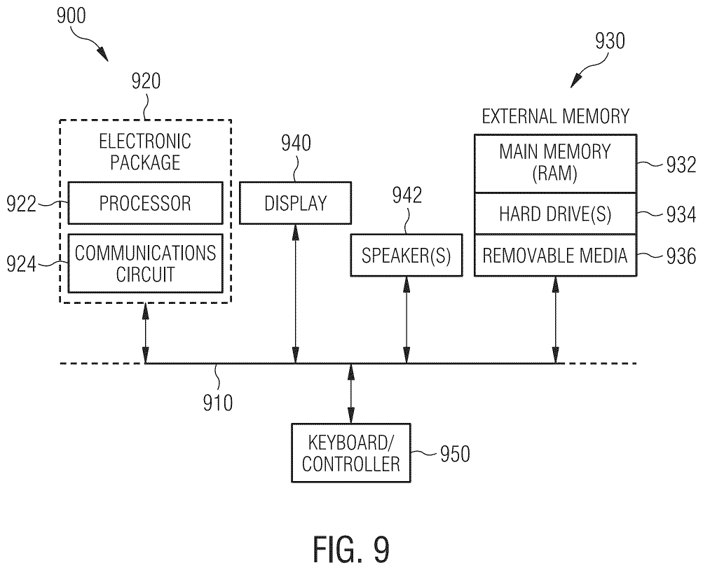

Further details and aspects are mentioned in connection with the examples described above or below. The example shown in FIGS. 7, 8 may include one or more optional additional features corresponding to one or more aspects mentioned in connection with the proposed concept or one or more examples described above (e.g., FIGS. 1-6) or below (e.g., FIG. 9).

The following table 1 enumerates some exemplary numbers of x and PrNV for different y:

TABLE 1

| y | x | PrNV |
|---|---|---|
| 1000 | 6 | 5.459447 × 10\hat{ }{−33} |
| 1000 | 7 | 8.504372 × 10\hat{ }{−4} |
| 1000 | 8 | 0.51027381 (51.02%) |
| 1000 | 9 | 0.9379777 (93.80%) |
| 1000 | 10 | 0.99392507 (99.4%) |
| 1000 | 11 | 0.99942028 (99.94%) |
| 1000 | 12 | 0.99994481 (99.99%) |
| 100 | 3 | 1.62252 × 10\hat{ }{−43} |
| 100 | 4 | 0.37515721 (37.52%) |
| 100 | 5 | 0.9902917 (99.03%) |
| 100 | 6 | 0.99990293 (99.99%) |

FIG. 9 illustrates an example of a block diagram of an electronic apparatus 900 incorporating at least one electronic assembly 100 and/or method 300 described herein. Electronic apparatus 900 is-merely one example of an electronic apparatus in which forms of the electronic assemblies 100 and/or methods 300 described herein may be used. Examples of an electronic apparatus 900 include, but are not limited to, personal computers, tablet computers, mobile telephones, game devices, MP3 or other digital music players, etc. In this example, electronic apparatus 900 comprises a data processing system that includes a system bus 910 to couple the various components of the electronic apparatus 900. System bus 910 provides communications links among the various components of the electronic apparatus 900 and may be implemented as a single bus, as a combination of busses, or in any other suitable manner.

An electronic assembly 920 as describe herein may be coupled to system bus 910. The electronic assembly 920 may include any circuit or combination of circuits. In one embodiment, the electronic assembly 920 includes a processor 922 which can be of any type. As used herein, “processor” means any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, or any other type of processor or processing circuit.

Other types of circuits that may be included in electronic assembly 920 are a custom circuit, an application-specific integrated circuit (ASIC), or the like, such as, for example, one or more circuits (such as a communications circuit 924) for use in wireless devices like mobile telephones, tablet computers, laptop computers, two-way radios, and similar electronic systems. The IC can perform any other type of function.

The electronic apparatus 900 may also include an (external) memory 930, which in turn may include one or more memory elements suitable to the particular application, such as a main memory 932 in the form of random access memory (RAM), one or more hard drives 934, and/or one or more drives that handle removable media 936 such as compact disks (CD), flash memory cards, digital video disk (DVD), and the like.

The electronic apparatus 900 may also include a display device 940, one or more speakers 942, and a keyboard and/or controller 950, which can include a mouse, trackball, touch screen, voice-recognition device, or any other device that permits a system user to input information into and receive information from the electronic apparatus 900.

Further details and aspects are mentioned in connection with the examples described above. The example shown in FIG. 9 may include one or more optional additional features corresponding to one or more aspects mentioned in connection with the proposed concept or one or more examples described above (e.g., FIGS. 1-8).

In the following, some examples of the proposed concept are presented:

An example (e.g., example 1) relates to an apparatus comprising interface circuitry, machine-readable instructions and processing circuitry to execute the machine-readable instructions to store a first plurality of cryptographic authentication credentials configured to authenticate the apparatus, wherein each of the plurality of authentication credentials is provisioned to a second plurality of different apparatuses, select a first authentication credential from the first plurality of authentication credentials for authenticating the apparatus to a verifier, transmit a certificate of the selected first authentication credential to the verifier for authentication, receive revocation information from the verifier indicating whether the selected first authentication credential is revoked, select a second cryptographic credential from the first plurality of cryptographic credentials based on a stored counting index if the received revocation information indicates that the selected first authentication credential is revoked.

Another example (e.g., example 2) relates to a previous example (e.g., example 1) or to any other example, further comprising that the first plurality of cryptographic authentication credentials is selected from a third plurality of different cryptographic authentication credentials, the third plurality of different cryptographic authentication credentials are distributed across a fourth plurality of apparatuses, such that any two apparatuses of the fourth plurality share at most one cryptographic authentication credential in common.

Another example (e.g., example 3) relates to a previous example (e.g., one of the examples 1 to 2) or to any other example, further comprising that the processing circuitry is further to execute the machine-readable instructions sign a challenge received by the verifier using a private key of the first authentication credential if the received revocation information indicates that the selected first authentication credential is not revoked.

Another example (e.g., example 4) relates to a previous example (e.g., example 3) or to any other example, further comprising that the processing circuitry is further to execute the machine-readable instructions to establish a secure session to the verifier if the signature generated using the private key of the first authentication credential is verified successfully by the verifier.

Another example (e.g., example 5) relates to a previous example (e.g., one of the examples 1 to 4) or to any other example, further comprising that the stored counting index indicates a currently selected authentication credential from the first plurality of cryptographic authentication credentials stored by the apparatus.

Another example (e.g., example 6) relates to a previous example (e.g., one of the examples 1 to 5) or to any other example, further comprising that the processing circuitry is further to execute the machine-readable instructions to increment the stored counting index and select the second cryptographic authentication credential from the first plurality in response to determining that the currently selected authentication credential has been revoked.

Another example (e.g., example 7) relates to a previous example (e.g., one of the examples 1 to 6) or to any other example, further comprising that the processing circuitry is further to execute the machine-readable instructions to determine, prior to selecting the first authentication credential, whether the stored counting index is less than the total number of the first plurality of cryptographic authentication credentials.

Another example (e.g., example 8) relates to a previous example (e.g., one of the examples 1 to 7) or to any other example, further comprising that the processing circuitry selects authentication credentials from the first plurality of authentication credentials in a predetermined order based on the stored counting index.

Another example (e.g., example 9) relates to a previous example (e.g., example 8) or to any other example, further comprising that the processing circuitry is further to execute the machine-readable instructions to abort the authentication to the verifier if it is determined that the counting index is not less than the total number of the first plurality of authentication credentials.

Another example (e.g., example 10) relates to a previous example (e.g., one of the examples 1 to 9) or to any other example, further comprising that the processing circuitry is further to execute the machine-readable instructions to abort authentication to the verifier, if it is determined that all authentication credentials in the first plurality of authentication credentials have been revoked based on the revocation information.

Another example (e.g., example 11) relates to a previous example (e.g., one of the examples 1 to 10) or to any other example, further comprising non-volatile memory configured to store authentication data, and the processing circuitry being further to execute the machine-readable instructions to download the first plurality of cryptographic authentication credentials from an external source using the authentication data.

Another example (e.g., example 12) relates to a previous example (e.g., example 11) or to any other example, further comprising that the non-volatile memory is a fuse-based memory.

Another example (e.g., example 13) relates to a previous example (e.g., example 11) or to any other example, the apparatus further comprising a non-volatile memory configured to store the first plurality of cryptographic authentication credentials.

Another example (e.g., example 14) relates to a previous example (e.g., example 13) or to any other example, further comprising that the non-volatile memory is a fuse-based memory or a rewriteable non-volatile memory.

Another example (e.g., example 15) relates to a previous example (e.g., one of the examples 1 to 14) or to any other example, further comprising that the processing circuitry is further to execute the machine-readable instructions to receive a request from a verifier to authenticate the apparatus.

Another example (e.g., example 16) relates to a previous example (e.g., one of the examples 1 to 15) or to any other example, further comprising that each of the cryptographic authentication credentials comprises a certificate, and a private key, the certificate comprising the corresponding public key and a digital signature of an issuer.

Another example (e.g., example 17) relates to a previous example (e.g., one of the examples 1 to 16) or to any other example, further comprising that the certificate of a cryptographic authentication credential comprises at least one of a public key, a subject identifier, an issuer identifier, a validity period, or a digital signature issued of an issuer.

Another example (e.g., example 18) relates to a previous example (e.g., one of the examples 1 to 17) or to any other example, further comprising that the revocation information indicates whether the selected first authentication credential is currently valid or has been revoked.

An example (e.g., example 19) relates to a method for manufacturing apparatuses, the comprising selecting, for each apparatus of a fourth plurality of apparatuses, a first plurality of cryptographic authentication credentials from a third plurality of different cryptographic authentication credentials, provisioning each of the selected first plurality of cryptographic authentication credentials into a secure storage of the respective apparatus during manufacturing, wherein each cryptographic authentication credential of the third plurality of authentication credential is provisioned to a second plurality of different apparatuses of the fourth plurality of apparatuses, and wherein the selection of the first plurality of authentication credential for each apparatus is performed such that any two apparatuses of the fourth plurality of apparatuses share at most one cryptographic authentication credential of the third plurality of authentication credential of in common.

An example (e.g., example 20) relates to a method comprising storing a first plurality of cryptographic authentication credentials configured to authenticate the apparatus, wherein each of the plurality of authentication credentials is provisioned to a second plurality of different apparatuses, selecting a first authentication credential from the first plurality of authentication credentials for authenticating the apparatus to a verifier, transmitting a certificate of the selected first authentication credential to the verifier for authentication, receiving revocation information from the verifier indicating whether the selected first authentication credential is revoked, selecting a second cryptographic credential from the first plurality of cryptographic credentials based on a stored counting index if the received revocation information indicates that the selected first authentication credential is revoked.

Another example (e.g., example 21) relates to a previous example (e.g., example 20) or to any other example, further comprising that the first plurality of cryptographic authentication credentials is selected from a third plurality of different cryptographic authentication credentials, the third plurality of different cryptographic authentication credentials are distributed across a fourth plurality of apparatuses, such that any two apparatuses of the fourth plurality share at most one cryptographic authentication credential in common.

Another example (e.g., example 22) relates to a previous example (e.g., one of the examples 20 to 21) or to any other example, further comprising signing a challenge received by the verifier using a private key of the first authentication credential if the received revocation information indicates that the selected first authentication credential is not revoked.

Another example (e.g., example 23) relates to a previous example (e.g., example 22) or to any other example, further comprising establishing a secure session to the verifier if the signature generated using the private key of the first authentication credential is verified successfully by the verifier.

Another example (e.g., example 24) relates to a previous example (e.g., one of the examples 20 to 23) or to any other example, wherein the stored counting index indicates a currently selected authentication credential from the first plurality of cryptographic authentication credentials stored by the apparatus.

Another example (e.g., example 25) relates to a previous example (e.g., one of the examples 20 to 24) or to any other example, further comprising incrementing the stored counting index and select the second cryptographic authentication credential from the first plurality in response to determining that the currently selected authentication credential has been revoked.

Another example (e.g., example 26) relates to a previous example (e.g., one of the examples 20 to 25) or to any other example, further comprising determining, prior to selecting the first authentication credential, whether the stored counting index is less than the total number of the first plurality of cryptographic authentication credentials.

Another example (e.g., example 27) relates to a previous example (e.g., one of the examples 20 to 26) or to any other example, further comprising selecting authentication credentials from the first plurality of authentication credentials in a predetermined order based on the stored counting index.

Another example (e.g., example 28) relates to a previous example (e.g., example 27) or to any other example, further comprising aborting the authentication to the verifier if it is determined that the counting index is not less than the total number of the first plurality of authentication credentials.

Another example (e.g., example 29) relates to a previous example (e.g., one of the examples 20 to 28) or to any other example, further comprising aborting authentication to the verifier, if it is determined that all authentication credentials in the first plurality of authentication credentials have been revoked based on the revocation information.

Another example (e.g., example 30) relates to a previous example (e.g., one of the examples 20 to 29) or to any other example, further comprising receiving a request from a verifier to authenticate the apparatus.

Another example (e.g., example 31) relates to a previous example (e.g., one of the examples 20 to 30) or to any other example, further comprising that each of the cryptographic authentication credentials comprises a certificate, and a private key, the certificate comprising the corresponding public key and a digital signature of an issuer.

Another example (e.g., example 32) relates to a previous example (e.g., one of the examples 20 to 31) or to any other example, further comprising that the certificate of a cryptographic authentication credential comprises at least one of a public key, a subject identifier, an issuer identifier, a validity period, or a digital signature issued of an issuer.

Another example (e.g., example 33) relates to a previous example (e.g., one of the examples 20 to 32) or to any other example, further comprising that the revocation information indicates whether the selected first authentication credential is currently valid or has been revoked.

An example (e.g., example 34) relates to an apparatus comprising a processor circuitry configured to store a first plurality of cryptographic authentication credentials configured to authenticate the apparatus, wherein each of the plurality of authentication credentials is provisioned to a second plurality of different apparatuses, select a first authentication credential from the first plurality of authentication credentials for authenticating the apparatus to a verifier, transmit a certificate of the selected first authentication credential to the verifier for authentication, receive revocation information from the verifier indicating whether the selected first authentication credential is revoked, select a second cryptographic credential from the first plurality of cryptographic credentials based on a stored counting index if the received revocation information indicates that the selected first authentication credential is revoked.

An example (e.g., example 35) relates to a device comprising means for processing for storing a first plurality of cryptographic authentication credentials configured to authenticate the device, wherein each of the plurality of authentication credentials is provisioned to a second plurality of different devices, selecting a first authentication credential from the first plurality of authentication credentials for authenticating the device to a verifier, transmitting a certificate of the selected first authentication credential to the verifier for authentication, receiving revocation information from the verifier indicating whether the selected first authentication credential is revoked, selecting a second cryptographic credential from the first plurality of cryptographic credentials based on a stored counting index if the received revocation information indicates that the selected first authentication credential is revoked.

An example (e.g., example 36) relates to a non-transitory computer-readable medium storing instructions that, when executed by one or more processing circuitries, causing the one or more processing circuitries to perform a method comprising storing a first plurality of cryptographic authentication credentials configured to authenticate the apparatus, wherein each of the plurality of authentication credentials is provisioned to a second plurality of different apparatuses, selecting a first authentication credential from the first plurality of authentication credentials for authenticating the apparatus to a verifier, transmitting a certificate of the selected first authentication credential to the verifier for authentication, receiving revocation information from the verifier indicating whether the selected first authentication credential is revoked, selecting a second cryptographic credential from the first plurality of cryptographic credentials based on a stored counting index if the received revocation information indicates that the selected first authentication credential is revoked.

Another example (e.g., example 37) relates to a computer program having a program code for performing the method of any one of examples 19 or 20 to 33 when the computer program is executed on a computer, a processor, or a programmable hardware component.

Another example (e.g., example 38) relates to a machine-readable storage including machine readable instructions, when executed, to implement a method or realize an apparatus as claimed in any pending claim.

Another example (e.g., example 39) relates to a computer-readable medium including program code, when executed, to cause a machine to perform the method of any one of examples 19 or 20 to 33.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus comprising interface circuitry, machine-readable instructions and processing circuitry to execute the machine-readable instructions to:
store a first plurality of cryptographic authentication credentials configured to authenticate the apparatus, wherein each of the plurality of authentication credentials is provisioned to a second plurality of different apparatuses;
select a first authentication credential from the first plurality of authentication credentials for authenticating the apparatus to a verifier;
transmit a certificate of the selected first authentication credential to the verifier for authentication;
receive revocation information from the verifier indicating whether the selected first authentication credential is revoked;
select a second cryptographic credential from the first plurality of cryptographic credentials based on a stored counting index if the received revocation information indicates that the selected first authentication credential is revoked.

2. The apparatus of claim 1, wherein the first plurality of cryptographic authentication credentials is selected from a third plurality of different cryptographic authentication credentials, the third plurality of different cryptographic authentication credentials are distributed across a fourth plurality of apparatuses, such that any two apparatuses of the fourth plurality share at most one cryptographic authentication credential in common.

3. The apparatus of claim 1, wherein the processing circuitry is further to execute the machine-readable instructions sign a challenge received by the verifier using a private key of the first authentication credential if the received revocation information indicates that the selected first authentication credential is not revoked.

4. The apparatus of claim 3, wherein the processing circuitry is further to execute the machine-readable instructions to establish a secure session to the verifier if the signature generated using the private key of the first authentication credential is verified successfully by the verifier.

5. The apparatus of claim 1, wherein the stored counting index indicates a currently selected authentication credential from the first plurality of cryptographic authentication credentials stored by the apparatus.

6. The apparatus of claim 1, wherein the processing circuitry is further to execute the machine-readable instructions to increment the stored counting index and select the second cryptographic authentication credential from the first plurality in response to determining that the currently selected authentication credential has been revoked.

7. The apparatus of claim 1, wherein the processing circuitry is further to execute the machine-readable instructions to determine, prior to selecting the first authentication credential, whether the stored counting index is less than the total number of the first plurality of cryptographic authentication credentials.

8. The apparatus of claim 1, wherein the processing circuitry selects authentication credentials from the first plurality of authentication credentials in a predetermined order based on the stored counting index.

9. The apparatus of claim 8, wherein the processing circuitry is further to execute the machine-readable instructions to abort the authentication to the verifier if it is determined that the counting index is not less than the total number of the first plurality of authentication credentials.

10. The apparatus of claim 1, wherein the processing circuitry is further to execute the machine-readable instructions to abort authentication to the verifier, if it is determined that all authentication credentials in the first plurality of authentication credentials have been revoked based on the revocation information.

11. The apparatus of claim 1, further comprising:
non-volatile memory configured to store authentication data; and
the processing circuitry being further to execute the machine-readable instructions to download the first plurality of cryptographic authentication credentials from an external source using the authentication data.

12. The apparatus of claim 11, wherein the non-volatile memory is a fuse-based memory.

13. The apparatus of claim 1 further comprising a non-volatile memory configured to store the first plurality of cryptographic authentication credentials.

14. The apparatus of claim 13, wherein the non-volatile memory is a fuse-based memory or a rewriteable non-volatile memory.

15. The apparatus of claim 1, wherein the processing circuitry is further to execute the machine-readable instructions to receive a request from a verifier to authenticate the apparatus.

16. The apparatus of claim 1, wherein each of the cryptographic authentication credentials comprises a certificate, and a private key, the certificate comprising the corresponding public key and a digital signature of an issuer.

17. The apparatus of claim 1, wherein the certificate of a cryptographic authentication credential comprises at least one of a: public key, a subject identifier, an issuer identifier, a validity period, or a digital signature issued of an issuer.

18. The apparatus of claim 1, wherein the revocation information indicates whether the selected first authentication credential is currently valid or has been revoked.

19. A non-transitory computer-readable medium storing instructions A method for manufacturing apparatuses, the comprising:
selecting, for each apparatus of a fourth plurality of apparatuses, a first plurality of cryptographic authentication credentials from a third plurality of different cryptographic authentication credentials;
provisioning each of the selected first plurality of cryptographic authentication credentials into a secure storage of the respective apparatus during manufacturing,
wherein each cryptographic authentication credential of the third plurality of authentication credential is provisioned to a second plurality of different apparatuses of the fourth plurality of apparatuses, and
wherein the selection of the first plurality of authentication credential for each apparatus is performed such that any two apparatuses of the fourth plurality of apparatuses share at most one cryptographic authentication credential of the third plurality of authentication credential of in common.

20. A non-transitory computer-readable medium storing instructions that, when executed by one or more processing circuitries, causing the one or more processing circuitries to perform a method comprising:
storing a first plurality of cryptographic authentication credentials configured to authenticate the apparatus, wherein each of the plurality of authentication credentials is provisioned to a second plurality of different apparatuses;
selecting a first authentication credential from the first plurality of authentication credentials for authenticating the apparatus to a verifier;
transmitting a certificate of the selected first authentication credential to the verifier for authentication;
receiving revocation information from the verifier indicating whether the selected first authentication credential is revoked;
selecting a second cryptographic credential from the first plurality of cryptographic credentials based on a stored counting index if the received revocation information indicates that the selected first authentication credential is revoked.
